(19) United States
(12) Patent Application Publication
(10) Pub. No.: US 2016/0257489 A1
(43) Pub. Date: Sep. 8, 2016

(54) Garbage Bag Grabber

(71) Applicant: Janet Quarterman, Cleveland, OH (US)

(72) Inventor: Janet Quarterman, Cleveland, OH (US)

(21) Appl. No.: 14/639,392

(22) Filed: Mar. 5, 2015

(51) Int. Cl. B65F 1/14

(52) U.S. Cl. CPC B65F 1/1415

(57) ABSTRACT

The GBG is a plastic bag grabber or holder. The purpose of the GBG is to hold plastic trash bags of all sizes easier. The GBG simply holds the upper portion of the plastic garbage bags. This product allows the garbage to be disposed of easier, the bags to be changed easier and the area to be kept cleaner.

### RELATED APPLICATIONS

Garbage bags, Trash cans

### DESCRIPTION

Garbage Bag Grabbers are essentially made out of two main pieces. the top portion and the bottom portion.

The top portion is made of pointed wooden pieces that will grab the plastic containers. The wooden pieces are reinforced by crossing over each other.

These wooden pieces are also reinforced by being mounted on the top of two levels of wooden chords. The chords are connected with two tie beams which ultimately will form a circle. The sizes of the GBG top portion could vary in widths and heights.

The top portion is connected to a wooden or iron bottom or base. The base will simply support the upper portion of the invention. The bottom portion will have three legs and a round base at the bottom. The sizes of the GBG bottom portion could vary in widths and heights.

I have invented a new design for a Garbage Bag Grabber as set forth in the following specification:

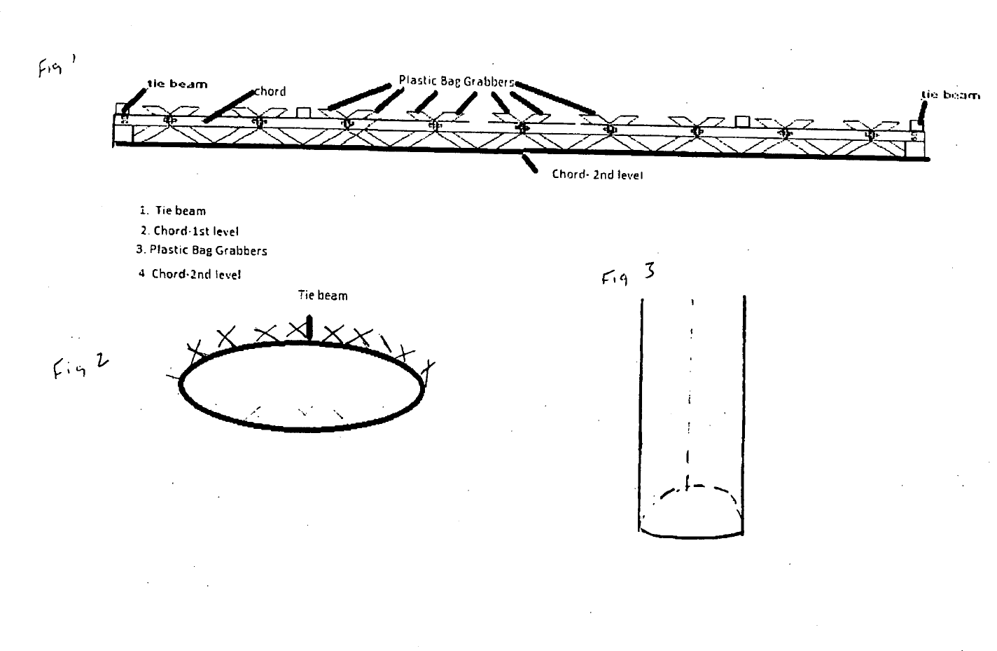

FIG. 1 is an elevated extended side view of the top portion of a Garbage Bag Grabber showing my new design;

FIG. 2 is the elevated top portion which is connected view thereof;

FIG. 3 is the bottom portion view thereof;

I claim: the ornamental design for a Garbage Bag Grabber as shown.

1. The Garbage Bag Grabber claims to make garbage bags easier to use, maintain, and dispose.
